(19) United States
(12) Patent Application Publication
(10) Pub. No.: US 2008/0196534 A1
(43) Pub. Date: Aug. 21, 2008

(54) Steering column assembly comprising a bushing assembly of elongated pins

(76) Inventors: Marvin V. Manwaring, Clio, MI (US); Ravi Ravindra, Saginaw, MI (US); Melvin L. Tinnin, Clio, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/708,207

(22) Filed: Feb. 20, 2007

(51) Int. Cl. B62D 1/16

(52) U.S. Cl. 74/492

(57) ABSTRACT

A bushing assembly for a steering column assembly is provided. The steering column assembly includes an outer jacket defining a bore extending along a longitudinal axis. An inner jacket is disposed within the bore of the outer jacket. The bushing assembly is disposed between the outer jacket and the inner jacket to remove the lash between the outer jacket and the inner jacket. The bushing assembly includes a plurality of elongated split-pins partially disposed in a plurality of channels defined by the outer jacket. The elongated split-pins are transversely compressible relative to the longitudinal axis to bias against the inner jacket, thereby removing the lash.

### BACKGROUND OF THE INVENTION

1. Field of the Invention

The subject invention relates to a steering column assembly for a motor vehicle.

2. Description of the Prior Art

Typical steering column assemblies include an outer jacket attached to the vehicle. The outer jacket defines a bore, which extends along a longitudinal axis. An inner jacket is disposed within the bore of the outer jacket, and rotatably supports a steering shaft to which a steering wheel is attached. To ease assembly, the inner jacket is sized slightly smaller than the bore defined by the outer jacket, resulting in a loose fit between the inner jacket and the outer jacket. The difference in size between the bore of the outer jacket and the inner jacket is commonly referred to as the lash between the outer jacket and the inner jacket. Accordingly, a bushing assembly is disposed between the outer jacket and the inner jacket to remove the lash and prevent relative movement transverse to the longitudinal axis between the outer jacket and the inner jacket.

One example of the bushing assembly for removing the lash between the outer jacket and the inner jacket of a steering column assembly is disclosed in U.S. Pat. No. 6,389,923 (the '923 patent) issued to Barton et al. The bushing assembly of the '923 patent includes a plastic bushing molded in place between the outer jacket and the inner jacket. The outer jacket includes a plurality of inlets, and defines a system of channels within the bore of the outer jacket in communication with the inlets. The bushing assembly is created by injecting liquid plastic through the inlets into the system of channels, thereby forming a plastic bushing in place around the inner jacket. This is a very expensive method of producing and assembling the steering column assembly.

Another example of the bushing assembly for removing the lash between the outer jacket and the inner jacket of a steering column assembly is disclosed in U.S. Pat. No. 5,737,971 (the '971 patent) issued to Riefe et al. The bushing assembly of the '971 patent includes a plurality of channels disposed between the outer jacket and the inner jacket. The channels include a first race coupled to the inner jacket and a second race coupled to the outer jacket opposing the first race to form a circular channel between the first race and the second race. A plurality of spherical rolling elements are disposed in the circular channel. A bracket restrains the rolling elements disposed in each of the channels relative to the other rolling elements disposed in the same channel, i.e., each channel includes a bracket restraining a set of rolling elements relative to each other. At least some of the rolling elements disposed in each channel comprise an elastic material, so that the elastic rolling elements disposed within each of the channels remove the lash between the outer jacket and the inner jacket.

### SUMMARY OF THE INVENTION AND ADVANTAGES

The subject invention provides a steering column assembly for a motor vehicle. The assembly comprises an outer jacket, which defines a bore extending along a longitudinal axis. The outer jacket further defines a plurality of channels formed within the bore about the longitudinal axis. An inner jacket is disposed within the bore of the outer jacket. A plurality of elongated pins are each partially disposed within one of the plurality of channels and in contact with the inner jacket. The elongated pins are transversely compressible relative to the longitudinal axis to bias against the inner jacket to remove any lash between the outer jacket and the inner jacket.

Accordingly, the subject invention removes the lash between the outer jacket and the inner jacket with a minimal number of components and without the need for hot-injecting plastic to create the bushing assembly in place. The subject invention therefore provides an easily assembled and cost effective method of producing the steering column assembly.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a steering column assembly;

FIG. 2 is a front perspective view of an outer jacket of the steering column assembly;

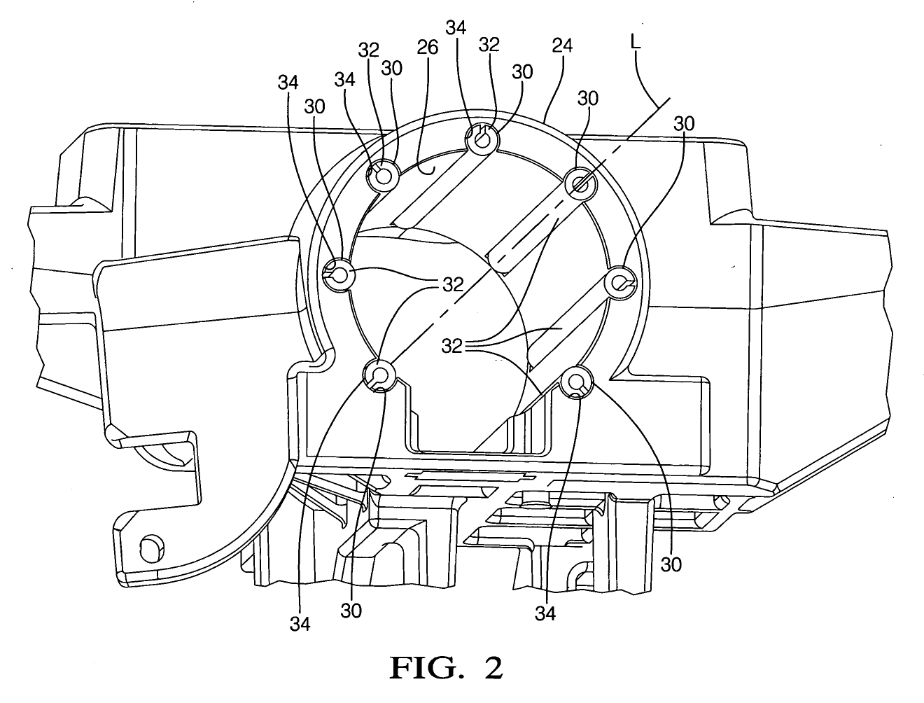

FIG. 3 is a front perspective view of the outer jacket and an inner jacket partially pressed into the outer jacket; and

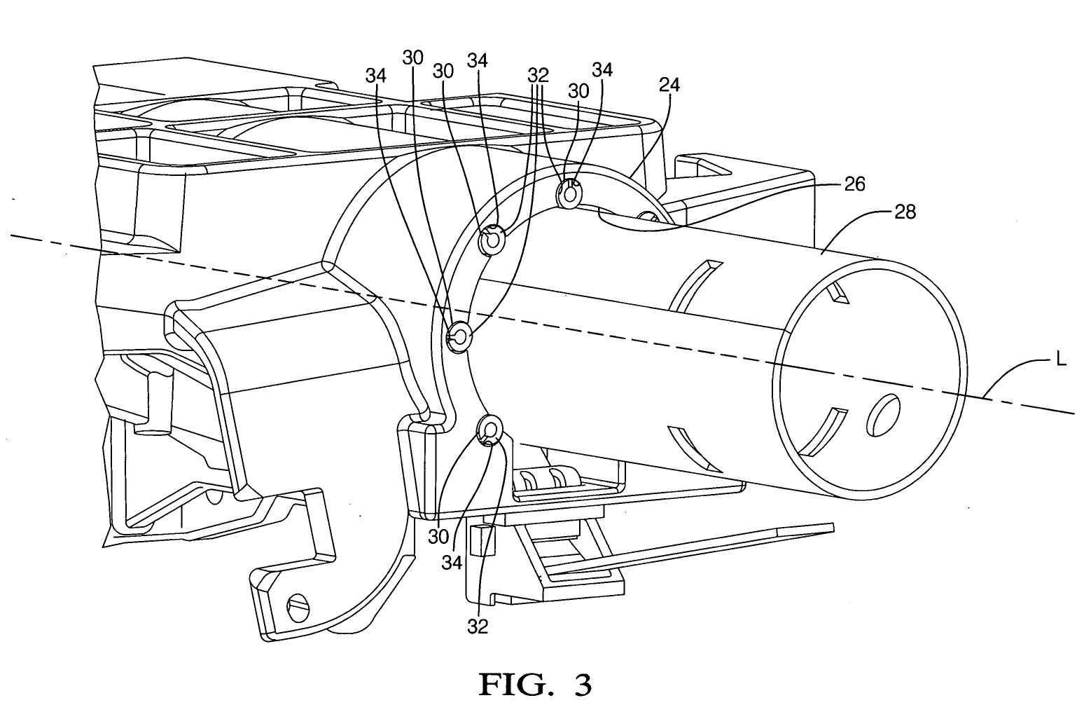

FIG. 4 is a rear perspective view of the outer jacket.

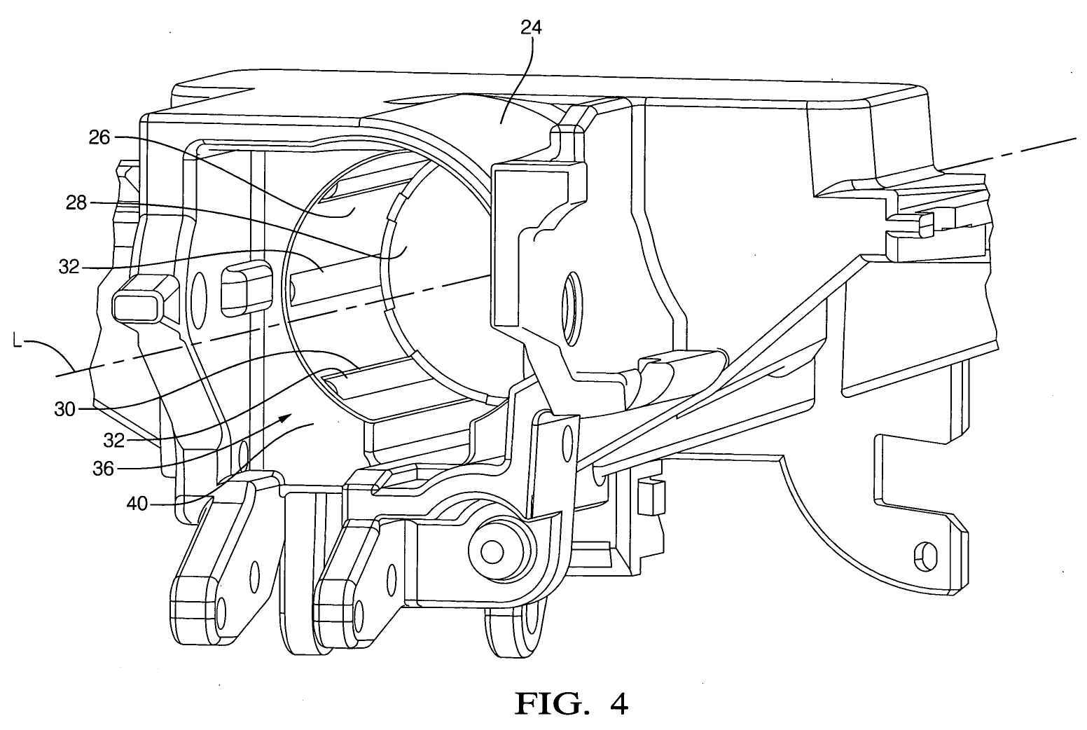

### DETAILED DESCRIPTION OF THE INVENTION

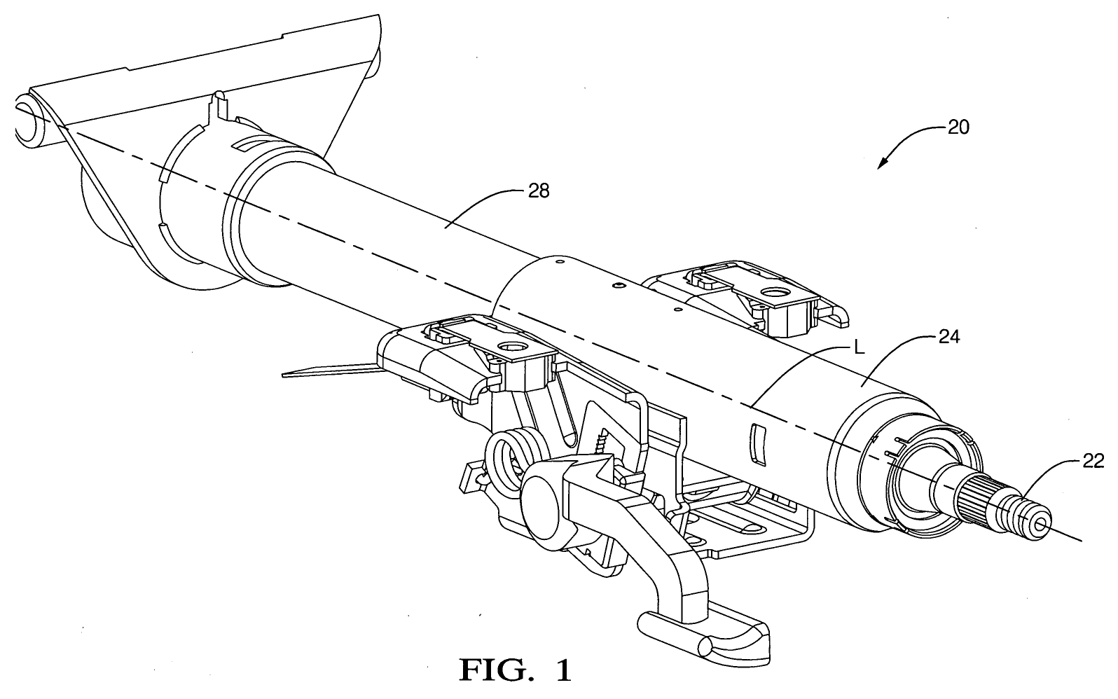

Referring to the Figures, wherein like numerals indicate corresponding parts throughout the several views, a steering column assembly is generally shown at 20 in FIG. 1. The steering column assembly 20 is attached to a vehicle, and rotatably supports a steering shaft 22 and an attached steering wheel (not shown) as is well known in the art.

The steering column assembly 20 comprises an outer jacket 24, which defines a bore 26 extending along a longitudinal axis L. An inner jacket 28 is disposed within the bore 26 of the outer jacket 24, with the steering shaft 22 rotatably supported within the inner jacket 28 as is well known in the art.

The outer jacket 24 further defines a plurality of channels 30 formed within the bore 26 about the longitudinal axis L. The plurality of channels 30 extend parallel the longitudinal axis L, and are radially spaced about the longitudinal axis L, equidistant from all other adjacent channels 30, i.e., the channels 30 are spaced equidistant from each other around a perimeter of the bore 26.

The steering column assembly 20 further comprises a bushing assembly 20, which includes a plurality of elongated pins 32. Each of the elongated pins 32 is partially disposed within one of the channels 30, and defines a slit 34 extending along a length of the elongated pin 32. The slit 34 in the elongate pin permits the elongated pin 32 to be transversely compressible relative to the longitudinal axis L. The elongated pins 32 bias against the inner jacket 28, and contacts the inner jacket 28 along a pre-determined length along the longitudinal axis L, to remove any lash between the outer jacket 24 and the inner jacket 28, i.e., the elongated pins 32 press against the inner jacket 28 to remove the lash between the outer jacket 24 and the inner jacket 28. As the inner jacket 28 biases against the plurality of pins, the plurality of pins are restrained from expanding by the channel 30, with the slit 34 permitting the elongated pin 32 to compress in response to the pressure applied by the inner jacket 28. It should be understood that the elongated pins 32 act as a spring in that each of the elongated pins 32 biases against the inner jacket 28 in an attempt to return to a pre-compressed shape. It should also be understood that the elongated pins 32 may include other types of pins capable of biasing against the inner jacket 28, such as a spiral wound pin. Preferably, the elongated pins 32 are manufactured from and comprise a polymer material or a metal material. However, it should be understood that the elongated pins 32 may comprise some other material not specifically described herein.

As shown in the Figures, the channels 30 include a cross section having a circular C-shape defining a first diameter and open to the bore 26. The elongated pins 32 each include a cross section also having a circular C-shape defining a second diameter, i.e., a circular cross section with the slit 34 defining the open portion of the C-shape. The second diameter of the elongated pins 32 is slightly less than the first diameter of the channel 30, so that the elongated pins 32 may be easily inserted into the channels 30 and retained therein. It should be understood that the C-shaped cross section of the channels 30 and the C-shaped cross section of the elongated pins 32 are complimentary in shape and cooperate to retain the elongated pins 32 within the channels 30 against lateral or transverse movement relative to the longitudinal axis L. However, it should also be understood that a portion of the elongated pin 32 must extend outward from the channel 30 into the bore 26 defined by the outer jacket 24 to sufficiently contact the inner jacket 28, i.e., the elongated pins 32 must extend into the bore 26 sufficiently to remove the lash between the outer jacket 24 and the inner jacket 28.

The steering column assembly 20 further comprises a retention mechanism 36 for axially retaining the elongated pins 32 within the plurality of channels 30 along the longitudinal axis L. It should be understood that the channel 30 cooperates with the elongate pins to restrain the elongated pins 32 laterally or transversely relative to the longitudinal axis L, and the retention mechanism 36 restrains the elongated pins 32 against movement along the longitudinal axis L. The retention mechanism 36 may include a first wall 38 and a second wall 40 disposed at opposing ends of each of the channels 30. It should be understood that the elongated pins 32 have a length equal to or less than the length of the channels 30. Alternatively, the retention mechanism 36 may include locking device 42, such as a snap ring in mechanical engagement with the upper jacket. It should be understood that the retention mechanism 36 may also include a combination of end walls and a locking device 42, i.e., an end wall at one end of each of the channels 30 and a locking device 42 at the other end of the channels 30. It should be understood that the retention mechanism 36 may include some other means than specifically described herein that is capable of restraining the elongated pins 32 within the channel 30 against movement along the longitudinal axis L. It should also be understood that some movement of the elongated pins 32 within the channel 30 is permissible, and that the retention mechanism 36 is intended to keep the elongated pins 32 from dislodging from the steering column assembly 20.

The foregoing invention has been described in accordance with the relevant legal standards; thus, the description is exemplary rather than limiting in nature. Variations and modifications to the disclosed embodiments may become apparent to those skilled in the art and do come within the scope of the invention. Accordingly, the scope of legal protection afforded this invention can only be determined by studying the following claims.

What is claimed is:

1. A steering column assembly for a motor vehicle, said assembly comprising:
an outer jacket defining a bore extending along a longitudinal axis and further defining a plurality of channels formed within said bore about said longitudinal axis;
an inner jacket disposed within said bore of said outer jacket; and
a plurality of elongated pins each partially disposed within one of said plurality of channels and in contact with said inner jacket with said plurality of elongated pins transversely compressible relative to said longitudinal axis to bias against said inner jacket for removing any lash between said outer jacket and said inner jacket.

2. An assembly as set forth in claim 1 wherein said plurality of elongated pins each define a slit extending along a length of said plurality of elongated pins.

3. An assembly as set forth in claim 1 wherein said plurality of channels are radially disposed about said longitudinal axis.

4. An assembly as set forth in claim 3 wherein all of said plurality of channels are spaced equidistant from all adjacent channels of said plurality of channels.

5. An assembly as set forth in claim 1 wherein said plurality of channels include a cross section having a C-shape defining a first diameter and open to said bore.

6. An assembly as set forth in claim 5 wherein said plurality of elongated pins each include a cross section having a C-shape defining a second diameter less than said first diameter of said channel.

7. An assembly as set forth in claim 1 wherein each of said plurality of channels includes a length and each of said elongated pins include a length equal to said length of said plurality of channels.

8. An assembly as set forth in claim 1 further comprising a retention mechanism for axially retaining said plurality of elongated pins within said plurality of channels along said longitudinal axis.

9. An assembly as set forth in claim 8 wherein said retention mechanism includes a first wall and a second wall disposed at opposing ends of each of said plurality of channels.

10. An assembly as set forth in claim 8 wherein said retention mechanism includes locking device in mechanical engagement with said upper jacket.

11. An assembly as set forth in claim 2 wherein said plurality of elongated pins are formed of a metal.

12. An assembly as set forth in claim 2 wherein said plurality of elongated pins are formed of a polymer material.
